(19) United States
(12) Patent Application Publication
(10) Pub. No.: US 2026/0296690 A1
(43) Pub. Date: Oct. 1, 2026

(54) SYSTEM FOR CONTROLLING WING SWEEP ANGLE AND UNMANNED AERIAL VEHICLE INCLUDING THE SAME

(71) Applicant: HANWHA AEROSPACE CO., LTD., Changwong-si (KR)

(72) Inventor: Hyun Chul LEE, Changwong-si (KR)

(73) Assignee: HANWHA AEROSPACE CO., LTD., Changwong-si (KR)

(21) Appl. No.: 19/240,832

(22) Filed: Jun. 17, 2025

(30) Foreign Application Priority Data
Mar. 25, 2025 (KR) 10-2025-0038312

(51) Int. Cl. B64U 40/20; B64U 10/25; B64U 30/12; B64U 101/15

(52) U.S. Cl. CPC B64U 40/20; B64U 10/25; B64U 30/12; F42B 10/18; B64C 3/40; B64U 2101/15; F42B 10/14

(57) ABSTRACT

A system for controlling a wing sweep angle includes: main wings rotatably connected to a fuselage; and a control assembly configured to control a sweep angle of the main wings, where the control assembly is further configured to deploy or retract the main wings, and fix the main wings at two or more sweep angles.

### CROSS-REFERENCE TO RELATED APPLICATION

This application is based on and claims priority to Korean Patent Application No. 10-2025-0038312, filed on Mar. 25, 2025, in the Korean Intellectual Property Office, the disclosure of which is incorporated by reference herein in its entirety.

### BACKGROUND

### 1. Field

The disclosure relates to a system for controlling a wing sweep angle and an unmanned aerial vehicle including the system.

### 2. Description of the Related Art

Recently, there has been a rapid development of unmanned aerial vehicles. In some examples, such as on the battle field, unmanned aerial vehicles may perform reconnaissance functions and be used for self-detonation missions.

On the other hand, aircraft may have different flight characteristics depending on a sweep angle of wings. That is, even for the same wing, an equivalent wingspan and the other related characteristics may change according to a value of the sweep angle, and thus, the flight characteristics may also change.

Therefore, an unmanned aerial vehicle may have a concept in which the flight characteristics are changed by adjusting the sweep angle of the wings depending on the nature of a mission, which allows for more efficient execution of the mission.

### SUMMARY

Provided is a system for controlling a wing sweep angle, the system having a simple structure to retract and fix wings after the wings have been deployed, and an unmanned aerial vehicle including the system.

Additional aspects will be set forth in part in the description which follows and, in part, will be apparent from the description, or may be learned by practice of the presented embodiments of the disclosure.

According to an aspect of the disclosure, a system for controlling a wing sweep angle may include: main wings rotatably connected to a fuselage; and a control assembly configured to control a sweep angle of the main wings, where the control assembly is further configured to deploy or retract the main wings, and fix the main wings at two or more sweep angles.

The system may further include hinge structures rotatably connecting the main wings to the fuselage.

The control assembly may include: a link assembly connected to the main wings; a first actuator; a first rod connected to the link assembly and elastically installed in the first actuator; a first elastic lock installed in the first actuator and configured to restrict a movement of the first rod; a second actuator fixed to the fuselage; a second rod installed in the second actuator and connected to the first actuator, the second rod being configured to move with the first actuator; a second elastic lock configured to restrict a movement of the second rod; and a trigger actuator including a trigger configured to release a restriction of the second rod.

The system may further include a first coil spring connected to the first rod in the first actuator and configured to generate an elastic force on the first rod.

A direction in which the first elastic lock is configured to restrict the movement of the first rod may be opposite to a direction in which the second elastic lock is configured to restrict the movement of the second rod.

The second rod may be elastically installed in the second actuator.

The system may further include a second coil spring connected to the second rod in the second actuator and configured to generate an elastic force on the second rod.

A direction of the elastic force acting on the second rod may be opposite to a direction of an elastic force acting on the first rod.

The first elastic lock may include a first lock including an inclined surface.

The second elastic lock may include a second lock including an inclined surface.

In a state in which the trigger actuator is operated, the trigger may release the restriction of the second rod, the second rod may move forward, and the second elastic lock may catch the second rod and restricts the movement of the second rod.

According to an aspect of the disclosure, an unmanned aerial vehicle may include: a fuselage; main wings rotatably connected to the fuselage; and a control assembly configured to control a sweep angle of the main wings, where the control assembly is further configured to deploy or retract the main wings, and fix the main wings at two or more sweep angles.

The control assembly may include: a link assembly connected to the main wings; a first actuator; a first rod connected to the link assembly and elastically installed in the first actuator; a first elastic lock installed in the first actuator and configured to restrict a movement of the first rod; a second actuator fixed to the fuselage; a second rod installed in the second actuator and connected to the first actuator, the second rod being configured to move with the first actuator; a second elastic lock configured to restrict a movement of the second rod; and a trigger actuator including a trigger configured to release a restriction of the second rod.

The system may further include a first coil spring connected to the first rod in the first actuator and configured to generate an elastic force on the first rod.

A direction in which the first elastic lock is configured to restrict the movement of the first rod may be opposite to a direction in which the second elastic lock is configured to restrict the movement of the second rod.

The second rod may be elastically installed in the second actuator.

The system may further include a second coil spring connected to the second rod in the second actuator and configured to generate an elastic force on the second rod.

A direction of the elastic force acting on the second rod may be opposite to a direction of an elastic force acting on the first rod.

The unmanned aerial vehicle may further include: a trigger controller configured to control the trigger actuator; and a thrust-generator configured to move the fuselage.

The trigger controller may be further configured to operate the trigger actuator to retract the main wings.

In a first state: the main wings may be overlapped with the fuselage by an external force, the first rod may be elastically compressed in the first actuator, and the second rod may be restricted by the trigger actuator, where the control assembly is further configured to change from the first state to a second state based on a release of the external force, where, in the second state: the main wings are fixed at a first sweep angle with respect to the fuselage, the first rod is restricted by the first elastic lock, and the second rod is restricted by the trigger actuator.

The control assembly may be further configured to change from the second state to a third state based on an operation of the trigger actuator, where, in the third state: the main wings are at a second sweep angle that is greater than the first sweep angle, the first rod is restricted by the first elastic lock, and the second rod is restricted by the second elastic lock.

According to an aspect of the disclosure, a system for controlling a wing sweep angle may include: main wings rotatably connected to a fuselage; and a control assembly configured to configured to deploy or retract the main wings, and fix the main wings at two or more sweep angles, where the control assembly includes: a link assembly connected to the main wings; a first actuator including: a first rod connected to the link assembly, a first coil spring connected to the first rod and configured to generate an elastic force on the first rod, and a first elastic lock configured to restrict a movement of the first rod; and a second actuator fixed to the fuselage and including: a second rod connected to the first actuator and configured to move with the first actuator, a second elastic lock configured to restrict a movement of the second rod, and a trigger actuator including a trigger configured to release a restriction of the second rod.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a schematic perspective view illustrating a state of main wings of an unmanned aerial vehicle in a first mode according to an embodiment;

FIG. 2 is a schematic perspective view illustrating a transition from the first mode to a second mode of the main wings of the unmanned aerial vehicle when a self-detonation attack is attempted, according to an embodiment;

FIG. 3 is a schematic perspective view illustrating a state of the main wings of the unmanned aerial vehicle in the second mode according to an embodiment;

FIG. 4 is a schematic perspective view illustrating components of a system for controlling a wing sweep angle, when the state of the main wings of the unmanned aerial vehicle is in the first mode, according to a first embodiment;

FIG. 5 is a schematic diagram illustrating a state of a first rod, a first actuator, a first coil spring, and a first elastic lock when the unmanned aerial vehicle is stored in a canister, according to an embodiment;

FIG. 6 is a schematic diagram illustrating a state of the first rod, the first actuator, the first coil spring, and the first elastic lock, when the unmanned aerial vehicle is launched from the canister and the state of the main wings is in the first mode, according to an embodiment;

FIG. 7 is a schematic diagram illustrating a state of a second rod, a second actuator, a second coil spring, a trigger actuator, and a second elastic lock when the unmanned aerial vehicle is stored in the canister or the state of the main wings is in the first mode, according to the first embodiment;

FIG. 8 is a schematic diagram illustrating a state of the second rod, the second actuator, the second coil spring, the trigger actuator, and the second elastic lock, when the state of the main wings of the unmanned aerial vehicle is in the second mode, according to the first embodiment;

FIG. 9 is a schematic diagram illustrating a state of a portion of the system for controlling the wing sweep angle when the unmanned aerial vehicle is stored in the canister, according to the first embodiment;

FIG. 10 is a schematic diagram illustrating a state of the portion of the system for controlling the wing sweep angle, when the unmanned aerial vehicle is launched from the canister and the state of the main wings is in the first mode, according to the first embodiment;

FIG. 11 is a schematic diagram illustrating a state of the portion of the system for controlling the wing sweep angle when the state of the main wings of the unmanned aerial vehicle is in the second mode, according to the first embodiment;

FIG. 12 is a schematic diagram illustrating components of the system for controlling the wing sweep angle when a state of the main wings of an unmanned aerial vehicle is in the first mode, according to the second embodiment;

FIG. 13 is a schematic diagram illustrating a state of a second rod, a second actuator, a trigger actuator, and a second elastic lock when the unmanned aerial vehicle is stored in a canister or a state of the main wings of the unmanned aerial vehicle is in the first mode, according to the second embodiment; and

FIG. 14 is a schematic diagram illustrating a state of the second rod, the second actuator, the trigger actuator, and the second elastic lock, when a state of the main wings of the unmanned aerial vehicle is in the second mode, according to the second embodiment.

### DETAILED DESCRIPTION

Reference will now be made in detail to embodiments, examples of which are illustrated in the accompanying drawings, wherein like reference numerals refer to like elements throughout. In this regard, the present embodiments are merely examples, and the disclosure may have different forms and should not be construed as being limited to the examples set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure will now be described in detail with reference to the accompanying drawings. Furthermore, in this specification and the accompanying drawings, components having substantially the same configuration are designated by the same reference numerals to avoid redundant explanations, and portions of the drawings may be exaggerated in terms of size or length ratios for clarity.

The disclosure will become clearer by referring to the embodiments described in detail below, with reference to the accompanying drawings. However, the disclosure is not limited to the embodiments disclosed below, and may be implemented in various other forms. These embodiments are provided merely to explain the disclosure and to enable a person skilled in the relevant art to fully understand the scope of the disclosure.

The terms used in this specification are for the purpose of describing the embodiments and are not intended to limit the disclosure. In this specification, the singular form includes the plural form unless otherwise stated in the context. The terms “comprises,” “comprising,” “includes,” “including,” “has,” “having,” and the like as used in the specification do not exclude the presence or addition of one or more other components, steps, actions, and/or elements. The terms “first,” “second,” and so on, may be used to describe various components, but the components should not be limited by these terms. The terms are used solely for the purpose of distinguishing one component from another.

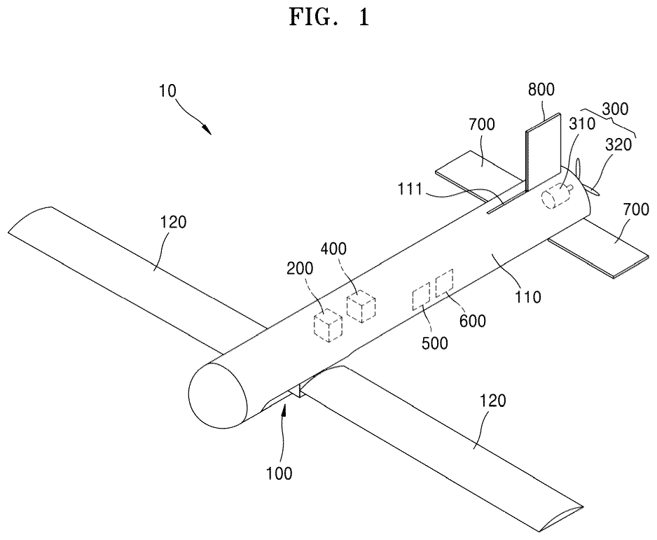

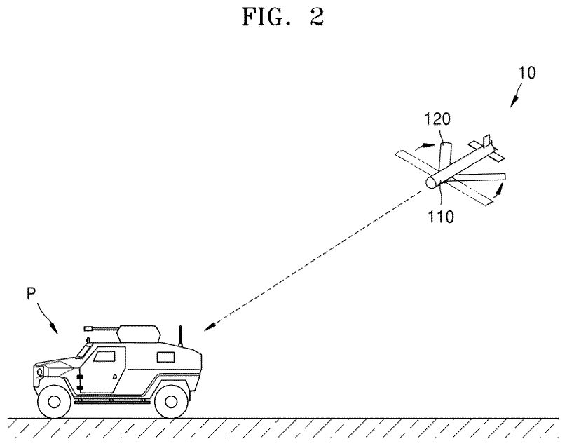

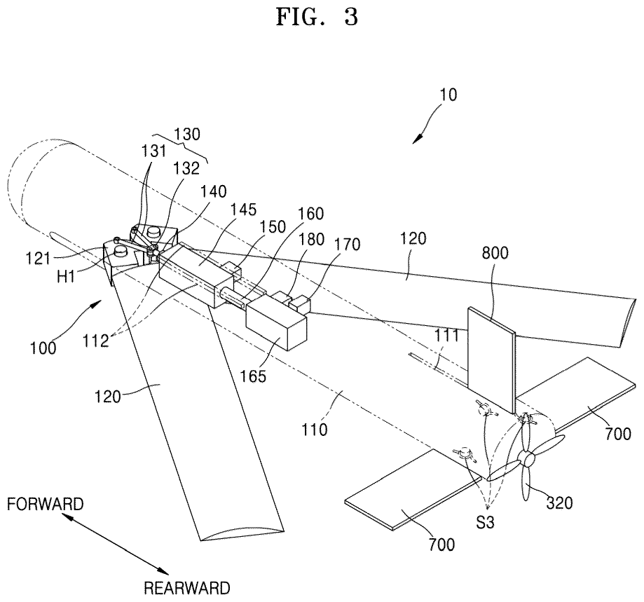

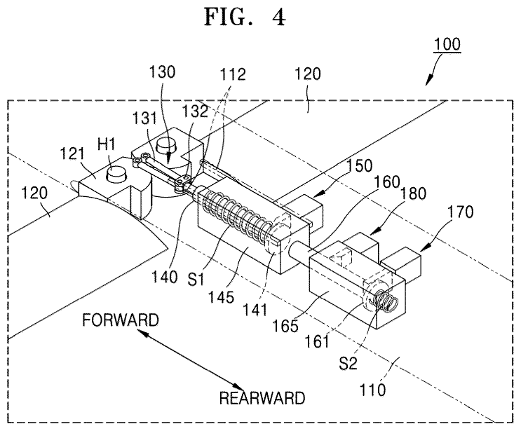

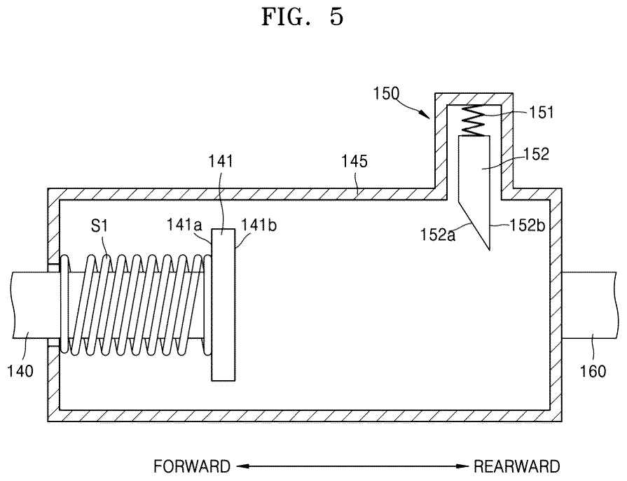

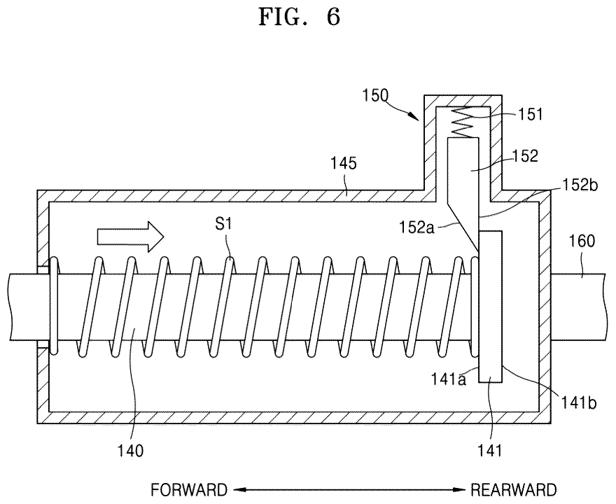

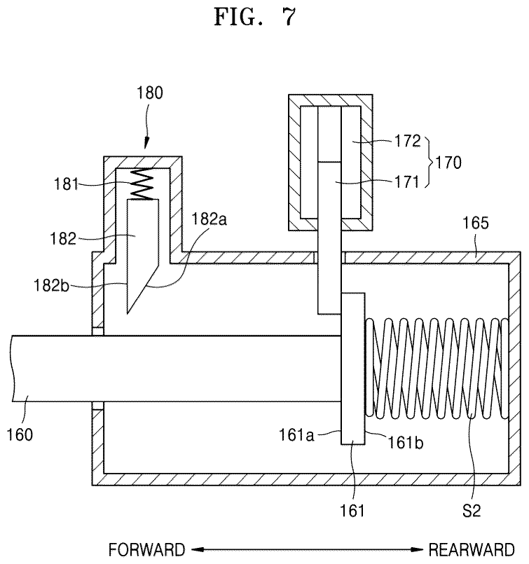

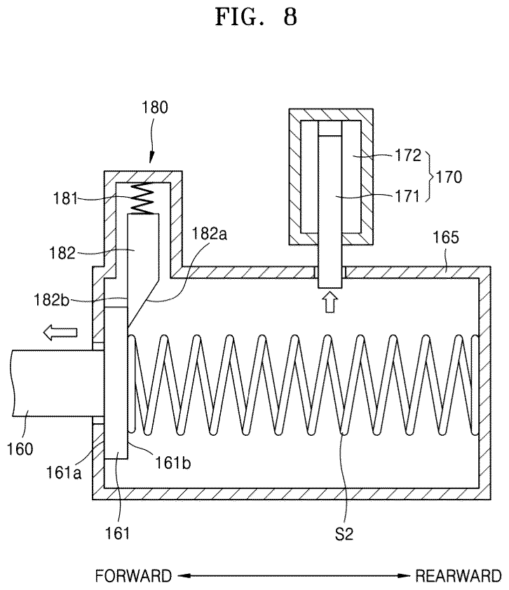

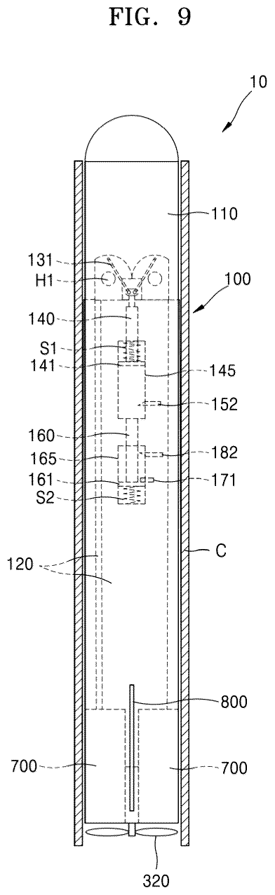

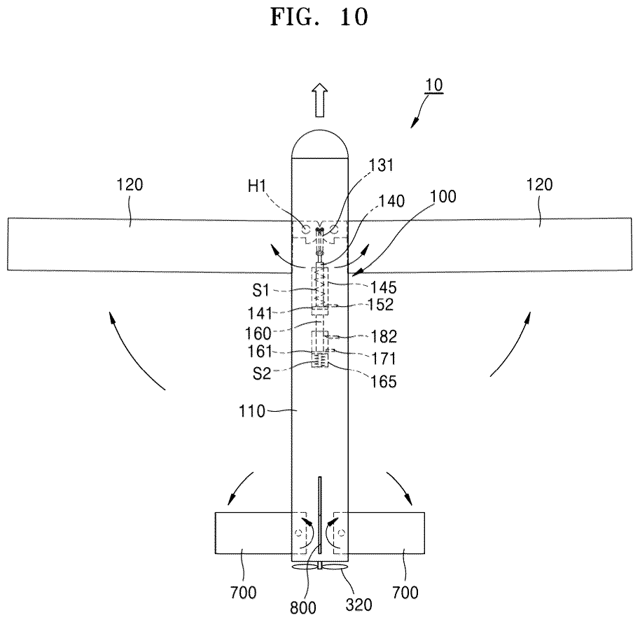

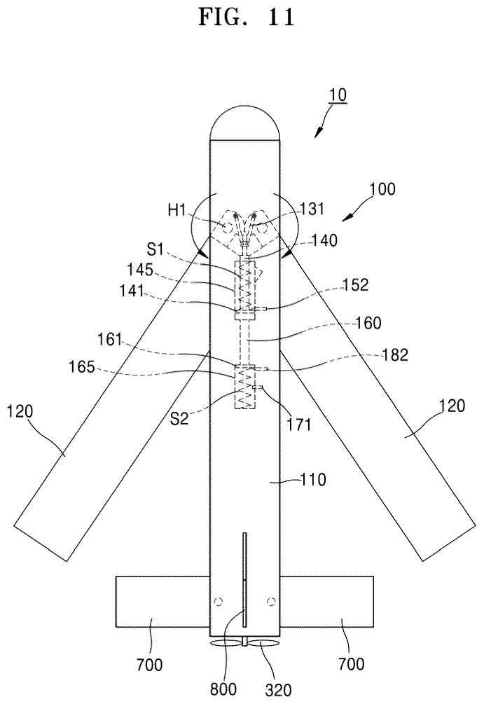

FIG. 1 is a schematic perspective view illustrating a state of the main wings of an unmanned aerial vehicle in a first mode according to an embodiment, FIG. 2 is a schematic perspective view illustrating a transition from the first mode to a second mode of the main wings of the unmanned aerial vehicle according to an embodiment when a self-detonation attack is attempted, and FIG. 3 is a schematic perspective view illustrating a state of the main wings of the unmanned aerial vehicle in the second mode according to an embodiment. Additionally, FIG. 4 is a schematic perspective view illustrating components of a system for controlling a wing sweep angle when the state of the main wings of the unmanned aerial vehicle is in the first mode, according to a first embodiment, FIG. 5 is a schematic diagram illustrating a state of a first rod, a first actuator, a first coil spring, and a first elastic lock when the unmanned aerial vehicle according to the first embodiment is stored in a canister, and FIG. 6 is a schematic diagram illustrating a state of the first rod, the first actuator, the first coil spring, and the first elastic lock when the unmanned aerial vehicle according to the first embodiment is launched from the canister and the state of the main wings is in the first mode. Furthermore, FIG. 7 is a schematic diagram illustrating a state of the second rod, the second actuator, the second coil spring, the trigger actuator, and the second elastic lock when the unmanned aerial vehicle according to the first embodiment is stored in the canister or the state of the main wings is in the first mode, and FIG. 8 is a schematic diagram illustrating a state of the second rod, the second actuator, the second coil spring, the trigger actuator, and the second elastic lock, when the state of the main wings of an unmanned aerial vehicle according to the first embodiment is in the second mode. Moreover, FIG. 9 is a schematic diagram illustrating a state of a portion of the system for controlling the wing sweep angle when the unmanned aerial vehicle according to the first embodiment is stored in the canister, FIG. 10 is a schematic diagram illustrating a state of the portion of the system for controlling the wing sweep angle when the unmanned aerial vehicle according to the first embodiment is launched from the canister and the state of the main wings is in the first mode, and FIG. 11 is a schematic diagram illustrating a state of a portion of the system for controlling the wing sweep angle when the state of the main wings of the unmanned aerial vehicle according to the first embodiment is in the second mode.

As illustrated in FIGS. 1-3, an unmanned aerial vehicle 10 according to the first embodiment may include a system 100 for controlling the wing sweep angle, a trigger controller 200, a thrust-generator 300, a main controller 400, a communication interface 500, a camera 600, horizontal tail wings 700, and a vertical tail wing 800.

The system 100 may control a sweep angle of main wings 120 and include a fuselage 110, main wings 120, a link assembly 130, a first rod 140, a first actuator 145, a first elastic lock 150, a second rod 160, a second actuator 165, a trigger actuator 170, and a second elastic lock 180. Here, the link assembly 130, the first rod 140, the first actuator 145, the first elastic lock 150, the second rod 160, the second actuator 165, the trigger actuator 170, and the second elastic lock 180 form a control assembly for controlling the angle of the main wings 120.

The unmanned aerial vehicle 10 according to the first embodiment may be stored in a cylindrical canister C before launch, and may be launched from the canister C when prompted. When stored in the canister C, the main wings 120, the horizontal tail wings 700, and the vertical tail wing 800 may be arranged to overlap or be accommodated in the fuselage 110, thus enabling storage in the canister C.

The unmanned aerial vehicle 10 according to an embodiment may have a structure launched from a canister C, but the disclosure is not limited thereto. That is, the unmanned aerial vehicle 10 according to an embodiment may be configured to be launched from a launcher having a shape different from a cylindrical canister.

The fuselage 110 may form a body portion of the unmanned aerial vehicle 10 and have a size that allows storage in the canister C.

The trigger controller 200, the main controller 400, the communication interface 500, and the camera 600 of the unmanned aerial vehicle 10 may be installed in the fuselage 110.

In addition, the fuselage 110 may include a storage portion 111 configured to accommodate the vertical tail wing 800 (see FIG. 3), and a guide 112 configured to guide a movement of the first actuator 145 may also be installed therein (see FIG. 4).

The guide 112 may have any configuration for guiding a movement of the first actuator 145. For example, the guide 112 may include a rail structure, but is not limited thereto.

The main wings 120 may be provided as a pair and may be rotatably mounted on the fuselage 110. That is, wing connectors 121 of the main wings 120 may be installed on the fuselage 110 by hinge structures including first hinge pins H1, so that the main wings 120 may be configured to rotate forward or backward with respect to the fuselage 110.

The link assembly 130 may be configured to transmit power by being connected to the main wings 120. The link assembly 130 may include a pair of links 131 and a link connection portion 132. One end of each link 131 may be hingedly connected to a respective one of the main wings 120, and the other end may be hingedly connected to the link connection portion 132.

The link connection portion 132 may be connected to the pair of links 131 and to the first rod 140. Accordingly, the link connection portion 132 may move in conjunction with a movement of the first rod 140.

The first rod 140 may be connected to the link assembly 130 and may be elastically installed in the first actuator 145.

One end of the first rod 140 may be connected to the link connection portion 132, and a first protrusion 141 configured to be caught by the first elastic lock 150 may be formed at the other end thereof.

Because the first rod 140 is elastically installed in the first actuator 145, when the unmanned aerial vehicle 10 is launched from the canister C and an external constraint on the main wings 120 is released, an elastic force may act on the first rod 140, and the link assembly 130 may rotate the main wings 120, so that the main wings 120 reach a first mode state.

A first coil spring S1 may be provided to elastically install the first rod 140. That is, when the unmanned aerial vehicle 10 is stored in the canister C, the first coil spring S1 may be in a compressed state, as shown in FIG. 5. However, when the unmanned aerial vehicle 10 is launched from the canister C, the constraint on the main wings 120 may be removed, so that the first coil spring S1, which has been compressed, extends and causes the first rod 140 to move rearward by the elastic force thereof, and causes the link connection portion 132 to move rearward. Then, the main wings 120 may gradually deploy by the action of the link assembly 130 and finally reach the first mode state (see FIGS. 4, 6, and 10). For the main wings 120 to be fully deployed and reach the first mode state, the first rod 140 may need to move sufficiently, and thus the first coil spring S1 and the first rod 140 should be appropriately designed in consideration of this.

According to the first embodiment, the first coil spring S1 may be arranged to elastically install the first rod 140, but the disclosure is not limited thereto. That is, according to an embodiment of the disclosure, the first rod 140 may only need to be elastically installed in the first actuator 145. For example, the first rod 140 may be elastically installed using pneumatic pressure, or may also be elastically installed using various elastic materials such as rubber bands, but the disclosure is not limited thereto.

The first actuator 145 may be installed to be slidable within the fuselage 110. The movement of the first actuator 145 may be guided by the guide 112 described above.

The first elastic lock 150 may be installed in the first actuator 145 to restrict a movement of the first rod 140.

The first elastic lock 150 may include a first elastic support 151 and a first lock 152.

The first elastic support 151 may be formed of a coil spring, one end of which may be fixed to the first actuator 145 and the other end may be fixed to the first lock 152.

The first lock 152 may include a first inclined surface 152a and a first locking surface 152b.

When the first protrusion 141 of the first rod 140 moves rearward and a rear surface 141b comes into contact with the first inclined surface 152a, the first elastic support 151 may be compressed, and as a result, the first lock 152 may move in the direction of the first elastic support 151.

As the first protrusion 141 of the first rod 140 moves further rearward, the first elastic support 151 may extend such that a front surface 141a of the first protrusion 141 is caught by the first locking surface 152b, whereby a forward movement of the first rod 140 may be restricted (see FIG. 6), and the main wings 120 may be in the first mode state.

The second rod 160 may be connected to the first actuator 145 and move together with the first actuator 145.

The second rod 160 may be elastically installed in the second actuator 165, and a direction of elastic force acting on the second rod 160 may be opposite to that of the first rod 140.

One end of the second rod 160 may be connected to the first actuator 145, and a second protrusion 161 may be formed at the other end and be configured to be caught by a trigger 171 and a second elastic lock 180.

Since the second rod 160 is elastically installed in the second actuator 165, when the unmanned aerial vehicle 10 switches from the first mode to the second mode as the main wings 120 are retracted for a self-detonation attack, an elastic force may act on the second rod 160, and the link assembly 130 may rotate the main wings 120, so that the main wings 120 enter the second mode state. In this case, the transition to the second mode state may also be assisted by drag acting on the unmanned aerial vehicle 10 during flight, and details related thereto will be described later.

A second coil spring S2 may be provided to elastically install the second rod 160. When the unmanned aerial vehicle 10 is stored in the canister C, or when the main wings 120 are in the fully deployed first mode state, the second coil spring S2 may be in a compressed state, as shown in FIG. 7.

When an increase in the flight speed of the unmanned aerial vehicle 10 is required, such as for the self-detonation attack, the main wings 120 may switch to the second mode, and the trigger controller 200 may operate in that case. As shown in FIG. 8, when the trigger 171 of the trigger actuator 170 moves upward, the engagement of the second protrusion 161 may be released, and the previously compressed second coil spring S2 may extend, thereby causing the second rod 160 to move forward. As a result, the first actuator 145 connected to the second rod 160 may also move forward, followed by the movement of the link assembly 130, thereby causing the main wings 120 to retract by a predetermined angle and to finally enter the second mode state (see FIGS. 3, 8, and 11). In addition, the retraction of the main wings 120 may be assisted not only by the elastic force of the second coil spring S2, but also by the drag acting on the main wings 120 while the unmanned aerial vehicle 10 is in flight.

Here, the sweep angle of the main wings 120 may be related to a moving distance of the second rod 160. That is, when the moving distance of the second rod 160 is large, the sweep angle of the main wings 120 may become large, and when the moving distance of the second rod 160 is small, the sweep angle of the main wings 120 may become small. Therefore, a designer may design the second rod 160 to move by a predetermined distance. For example, the moving distance of the second rod 160 may be designed to be shorter than the distance of the first rod 140, which is stored in the canister C and moves until the main wings 120 transition to the first mode state. If the moving distance of the second rod 160 becomes excessively long, the sweep angle of the main wings 120 also becomes excessively large, which may reduce lift and make it difficult for the unmanned aerial vehicle 10 to return in the event of mission cancellation.

According to the first embodiment, the second coil spring S2 may be provided to elastically install the second rod 160, but the disclosure is not limited thereto. That is, according to an embodiment of the disclosure, the second rod 160 may be elastically installed in the second actuator 165. For example, the second rod 160 may be elastically installed using pneumatic pressure, or using various elastic materials such as rubber bands, but the disclosure is not limited thereto.

In the first embodiment, the second rod 160 may be elastically installed in the second actuator 165, but the disclosure is not limited to this configuration. That is, according to an embodiment of the disclosure, the second rod 160 may be installed in such a manner that no elastic force acts between the second rod 160 and the second actuator 165. The detailed configuration thereof will be described in a second embodiment.

The second actuator 165 may be installed to be fixed to the fuselage 110.

In an embodiment, the trigger actuator 170 may include the trigger 171 for releasing the locking of the second rod 160 and an actuator 172.

The trigger actuator 170 may be installed in the second actuator 165 or the fuselage 110.

An initial state of the trigger 171 may be a state in which the second protrusion 161 of the second rod 160 is caught, as shown in FIG. 7. That is, in the initial state, a front surface 161a of the second protrusion 161 may be caught by the trigger 171.

The actuator 172 may control a movement of the trigger 171 in response to a signal from the trigger controller 200. The actuator 172 may be configured as a device capable of moving the trigger 171. For example, the actuator 172 may employ a motor such as a servo motor or may employ a pneumatic or hydraulic actuator, but the disclosure is not limited thereto.

As described above, when attempting to change a state of the main wings 120 from the first mode to the second mode for the self-detonation attack, the trigger controller 200 may drive the actuator 172 to move the trigger 171 upward, as shown in FIG. 8, thereby releasing a locking state of the second protrusion 161 and allowing the second rod 160 to move forward.

According to an embodiment, the second elastic lock 180 may restrict a movement of the second rod 160 and may be installed in the second actuator 165.

In an embodiment, the second elastic lock 180 may be installed in the second actuator 165, but the disclosure is not limited thereto. That is, according to an embodiment of the disclosure, the second elastic lock 180 may also be installed in the fuselage 110.

The second elastic lock 180 may include a second elastic support 181 and a second lock 182.

The second elastic support 181 may be configured as a coil spring, and may have one end fixed to the second actuator 165 and the other end fixed to the second lock 182.

The second lock 182 may include a second inclined surface 182a and a second locking surface 182b.

When the second protrusion 161 of the second rod 160 moves forward and the front surface 161a thereof comes into contact with the second inclined surface 182a, the second elastic support 181 may be compressed and the second lock 182 may move in a direction of the second elastic support 181.

As the second protrusion 161 of the second rod 160 further moves forward, the second elastic support 181 may extend, and a rear surface 161b of the second protrusion 161 may become caught by the second locking surface 182b, so that the second rod 160 is restricted from moving rearward (see FIG. 8), and the main wings 120 are in the second mode.

As described above, a direction in which the second elastic lock 180 restricts the movement of the second rod 160 is opposite to a direction in which the first elastic lock 150 restricts the movement of the first rod 140.

The trigger controller 200 may control the trigger actuator 170.

The trigger controller may 200 receive a command from a user or the main controller 400 and may control the trigger actuator 170 to move the trigger 171 when the retraction of the main wings 120 is required.

The trigger controller 200 may be physically implemented by analog and/or digital circuits including one or more of a logic gate, an integrated circuit, a microprocessor, a microcontroller, a memory circuit, a passive electronic component, an active electronic component, and the like, and may implement or execute software and/or firmware to perform the functions or operations described herein. For example, the trigger controller 200 may include memory such as read-only memory (ROM) and random access memory (RAM) for storing data, hardware such as a circuit board and integrated circuit chips for processing data, and related software and firmware, and may be configured to operate under the control of a user or a control algorithm.

The thrust-generator 300 may provide thrust for moving the fuselage 110, and may include a power generation device 310 and a propeller 320.

The power generation device 310 may include a motor, an engine, and various reducers.

The main controller 400 may be configured to control overall operation of the unmanned aerial vehicle 10. The main controller 400 may be physically implemented by analog and/or digital circuits including one or more of a logic gate, an integrated circuit, a microprocessor, a microcontroller, a memory circuit, a passive electronic component, an active electronic component, and the like, and may implement or execute software and/or firmware to perform the functions or operations described herein. The main controller 400 may include memory such as the ROM and the RAM for storing data, hardware such as a circuit board and integrated circuit chips for processing data, and software and firmware, and may be operated under the control of a user or a control algorithm.

According to an embodiment, the main controller 400 and the trigger controller 200 may be provided separately, but the disclosure is not limited thereto. That is, according to an embodiment of the disclosure, the software and hardware of the trigger controller 200 may be integrated into the main controller 400.

The communication interface 500 is a device configured to perform communication between a user and the unmanned aerial vehicle 10. A user may transmit commands to the main controller 400 of the unmanned aerial vehicle 10 via the communication interface 500, and may view received images obtained by the camera 600. The communication interface 500 may include any one or any combination of a digital modem, a radio frequency (RF) modem, an antenna circuit, a WiFi chip, and related software and/or firmware.

The communication interface 500 may include a commercial wireless communication device.

The camera 600 may be configured to capture a surrounding area while the unmanned aerial vehicle 10 performs reconnaissance. The camera 600 may be configured to control capturing directions in response to commands from the main controller 400, and may include a commercial camera device.

The horizontal tail wings 700 and the vertical tail wing 800 may be elastically mounted at a rear end portion of the fuselage 110.

The horizontal tail wings 700 and the vertical tail wing 800 may be elastically installed by the hinge-spring structures S3, so that when stored in the canister C, the horizontal tail wings 700 overlap the fuselage 110 and the vertical tail wing 800 is housed in the storage portion 111 of the fuselage 110. When the unmanned aerial vehicle 10 is launched from the canister C, the horizontal tail wings 700 and the vertical tail wing 800 may be deployed by the elastic force of the torsion spring, as shown in FIGS. 1 and 10.

Hereinafter, with reference to FIGS. 1 to 11, operations of the system 100 for controlling the wing sweep according to the first embodiment are described in detail.

First, when the unmanned aerial vehicle 10 is stored in the canister C, the main wings 120 and the horizontal tail wings 700 may overlap the fuselage 110, and the vertical tail wing 800 may be accommodated in the fuselage 110, as shown in FIG. 9. In that case, the first coil spring S1 may be in the compressed state as shown in FIG. 5, and the torsion springs included in the hinge-spring structures S3 of the horizontal tail wings 700 and the vertical tail wing 800 may also be storing elastic energy. The canister C may inhibit the action of the main wings 120, the horizontal tail wings 700, and the vertical tail wing 800 from deploying.

When a user launches the unmanned aerial vehicle 10 from the canister C, the thrust-generator 300 of the unmanned aerial vehicle 10 may be actuated, and the inhibition by the canister C may be removed, such that the main wings 120, the horizontal tail wings 700, and the vertical tail wing 800 are deployed by respective actions of the first coil spring S1 and the torsion springs of the hinge-spring structures S3, as shown in FIG. 10. According to an embodiment, during the process of deploying the main wings 120, when the unmanned aerial vehicle 10 is launched from the canister C, the inhibition by the canister C may be removed, and the previously compressed first coil spring S1 may extend, causing the first rod 140 to move rearward by its elastic force, gradually deploying the main wings 120 through the operation of the link assembly 130.

Once the first rod 140 is moved rearward by the elastic force, the first protrusion 141 may be caught by the first lock 152, thereby restricting the forward movement of the first rod 140. This may prevent the main wings 120 from folding due to drag during reconnaissance flight, and the main wings 120 may enter the first mode state (see FIGS. 4, 6, and 10).

The unmanned aerial vehicle 10 may perform reconnaissance flight using thrust generated by the thrust-generator 300 and, when a target P is identified and a point for performing a self-detonation attack is reached, it may become necessary to increase flight speed to ensure a successful attack. In that case, a user or the main controller 400 may cause the main wings 120 to be retracted by a predetermined angle through control, thereby changing the state of the main wings 120 from the first mode to the second mode. That is, the sweep angle of the main wings 120 may change.

Under a command from a user or the main controller 400, the trigger controller 200 may control the trigger actuator 170 to move the second rod 160 forward. That is, as shown in FIG. 8, when the trigger 171 is moved upward to release the locking state of the second protrusion 161, the previously compressed second coil spring S2 may extend and move the second rod 160 forward by the elastic force thereof. When the second rod 160 moves further forward, the second protrusion 161 may be caught by the second lock 182, so that a backward movement thereof is restricted. This may prevent the main wings 120 from returning to the first mode during flight for a self-detonation attack.

When the second rod 160 moves forward, the first actuator 145 connected thereto may also move forward, and in turn, the link assembly 130 may be moved so that the main wings 120 are retracted by a predetermined angle and enter the second mode state (see FIGS. 3, 8, and 11).

When the main wings 120 enter the second mode state, the sweep angle may be increased to allow an increase in flight speed of the unmanned aerial vehicle 10, thereby increasing the success rate of a self-detonation attack toward the target P.

As described above, in the system 100 and the unmanned aerial vehicle 10 according to the first embodiment, it may be unnecessary to provide a separate actuator or gearbox for the retraction of the main wings 120, thereby reducing manufacturing cost and weight and facilitating installation and maintenance due to the simple structure.

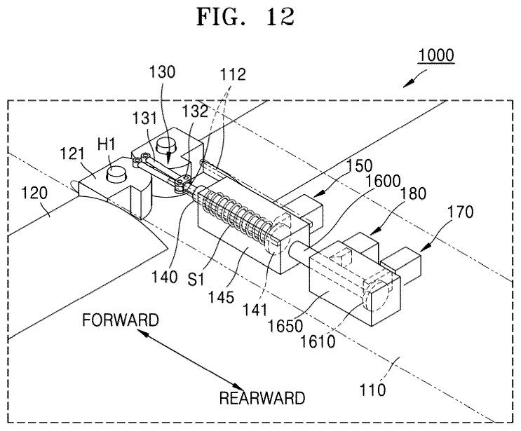

Hereinafter, with reference to FIGS. 12 to 14, a system 1000 for controlling a wing sweep angle, according to a second embodiment will be described, with focus placed on differences from the system 100 according to the first embodiment.

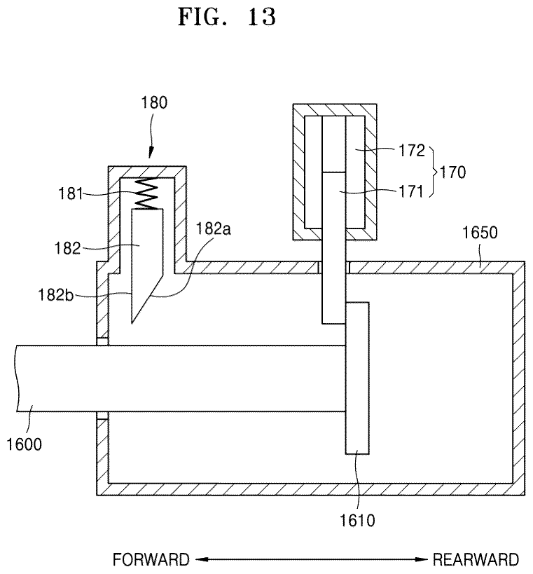

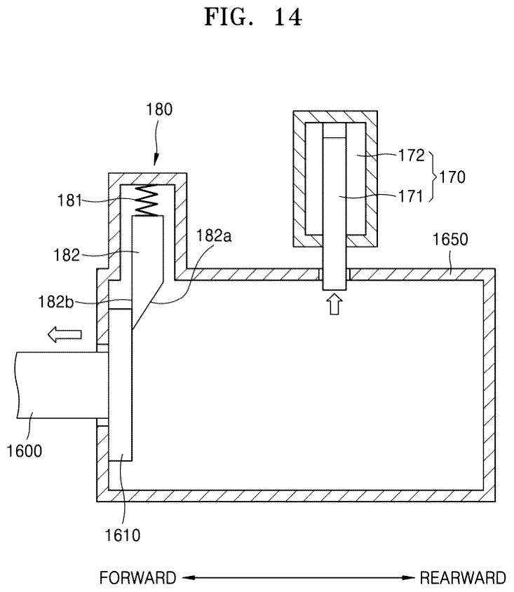

FIG. 12 is a schematic diagram illustrating components of a control system of wing sweep angle when a state of the main wings of an unmanned aerial vehicle according to a second embodiment is in a first mode. Also, FIG. 13 is a schematic diagram illustrating a state of a second rod, a second actuator, a trigger actuator, and a second elastic lock when the unmanned aerial vehicle according to the second embodiment is stored in a canister or a state of the main wings of the unmanned aerial vehicle is in a first mode, and FIG. 14 is a schematic diagram illustrating a state of the second rod, the second actuator, the trigger actuator, and the second elastic lock, when a state of the main wings of the unmanned aerial vehicle according to the second embodiment is in a second mode.

One difference between the system 1000 according to the second embodiment and the system 100 according to the first embodiment is that a second rod 1600 of the system 1000 may not be elastically installed in a second actuator 1650.

Accordingly, the system 1000 according to the second embodiment may not include a configuration corresponding to the second coil spring S2 of the first embodiment.

Because the remaining configurations and operations may be employed in the same manner as those in the first embodiment described above, the reference numerals used in the drawings are also the same as those in the first embodiment, except for the second rod 1600 and the second actuator 1650.

As described above, the system 1000 according to the second embodiment may not include the second coil spring S2 as in the first embodiment, while the remaining parts are identical. Therefore, descriptions of the state in which the second coil spring S2 is not involved, that is, the state in which the unmanned aerial vehicle 10 is stored in the canister C and the state of the unmanned aerial vehicle 10 is in the first mode, are the same as those described in the first embodiment, and thus detailed descriptions thereof will be omitted here.

Compared to the system 100 of the first embodiment, the system 1000 of the second embodiment may differ in the manner in which the state of the main wings 120 is switched from the first mode to the second mode. This is because the second embodiment may not include the second coil spring S2, so the mode switching from the first mode to the second mode may be performed solely by the drag acting on the main wings 120.

That is, when the unmanned aerial vehicle 10 performs reconnaissance flight, drag acts on the main wings 120, and such drag tends to retract each of the main wings 120 rearward. Such drag may generate torque that tends to rotate the main wings 120 about respective ones of the first hinge pins H1.

Therefore, when a release operation of the trigger actuator 170 occurs during reconnaissance flight, the link assembly 130 may act due to such drag, thereby causing the first actuator 145 and the second rod 1600 to move forward. Then, as the second rod 1600 moves further forward, a second protrusion 1610 may be caught by the second lock 182, thereby fixing the second mode state (see FIG. 14).

In the case of the second embodiment, because switching to the second mode is achieved only by drag acting on the main wings 120 during reconnaissance flight, the shape of the main wings 120 and the hinge structure by which the main wings 120 are mounted on the fuselage 110 may be appropriately designed to facilitate rotation of the main wings 120 during the transition to the second mode.

As described above, in the system 1000 and the unmanned aerial vehicle 10 according to the second embodiment, the second coil spring S2 may be unnecessary as well, so that the main wings 120 may be retracted with a simpler structure than in the system 100 of the first embodiment. Accordingly, in the system 1000 of the second embodiment, no separate actuator or gearbox may be required for the retraction of the main wings 120, thereby reducing manufacturing costs and weight, and enabling easier installation and maintenance due to the simple structure.

In the above-described first and second embodiments, the reason for switching the state of the main wings 120 from the first mode to the second mode has been described mainly with respect to self-detonation attack, but the disclosure is not limited thereto. That is, because the retraction of the main wings 120 generally increases flight speed, the disclosure may be applied without limitation to any case in which it is necessary to increase flight speed, even if it is not the self-detonation attack.

The systems 100 and 1000 according to the first and second embodiments described above are applied to the unmanned aerial vehicle, but the disclosure is not limited thereto. That is, systems 100 and 1000 according to an embodiment of the disclosure may also be applied to manned aircraft.

A system for controlling a wing sweep angle and an unmanned aerial vehicle according to aspects of the disclosure may effectively adjust a wing sweep angle with a simple structure, thereby reducing manufacturing cost and weight, and facilitating maintenance.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure. Accordingly, the scope of various embodiments of the disclosure should be interpreted as encompassing all modifications or variations derived based on the technical spirit of various embodiments of the disclosure in addition to the embodiments disclosed herein.

1. A system for controlling a wing sweep angle, the system comprising:
main wings rotatably connected to a fuselage; and
a control assembly configured to control a sweep angle of the main wings,
wherein the control assembly is further configured to deploy or retract the main wings, and fix the main wings at two or more sweep angles, and
wherein the control assembly comprises:
a link assembly connected to the main wings;
a first actuator;
a first rod connected to the link assembly and elastically installed in the first actuator;
a first elastic lock installed in the first actuator and configured to restrict a movement of the first rod;
a second actuator fixed to the fuselage;
a second rod installed in the second actuator and connected to the first actuator, the second rod being configured to move with the first actuator;
a second elastic lock configured to restrict a movement of the second rod; and
a trigger actuator comprising a trigger configured to release a restriction of the second rod.

2. (canceled)

3. (canceled)

4. The system of claim 1, further comprising a first coil spring connected to the first rod in the first actuator and configured to generate an elastic force on the first rod.

5. The system of claim 1, wherein a direction in which the first elastic lock is configured to restrict the movement of the first rod is opposite to a direction in which the second elastic lock is configured to restrict the movement of the second rod.

6. The system of claim 1, wherein the second rod is elastically installed in the second actuator.

7. The system of claim 6, further comprising a second coil spring connected to the second rod in the second actuator and configured to generate an elastic force on the second rod.

8. The system of claim 6, wherein a direction of an elastic force acting on the second rod is opposite to a direction of an elastic force acting on the first rod.

9. The system of claim 1, wherein the first elastic lock comprises a first lock comprising an inclined surface.

10. The system of claim 1, wherein the second elastic lock comprises a second lock comprising an inclined surface.

11. The system of claim 1, wherein, in a state in which the trigger actuator is operated, the trigger releases the restriction of the second rod, the second rod moves forward, and the second elastic lock catches the second rod and restricts the movement of the second rod.

12. An unmanned aerial vehicle comprising:
a fuselage;
main wings rotatably connected to the fuselage; and
a control assembly configured to control a sweep angle of the main wings,
wherein the control assembly is further configured to deploy or retract the main wings, and fix the main wings at two or more sweep angles, and
wherein the control assembly comprises:
a link assembly connected to the main wings;
a first actuator;
a first rod connected to the link assembly and elastically installed in the first actuator;
a first elastic lock installed in the first actuator and configured to restrict a movement of the first rod;
a second actuator fixed to the fuselage;
a second rod installed in the second actuator and connected to the first actuator, the second rod being configured to move with the first actuator;
a second elastic lock configured to restrict a movement of the second rod; and
a trigger actuator comprising a trigger configured to release a restriction of the second rod.

13. (canceled)

14. The unmanned aerial vehicle of claim 12, further comprising a first coil spring connected to the first rod in the first actuator and configured to generate an elastic force on the first rod.

15. The unmanned aerial vehicle of claim 12, wherein a direction in which the first elastic lock is configured to restrict the movement of the first rod is opposite to a direction in which the second elastic lock is configured to restrict the movement of the second rod.

16. The unmanned aerial vehicle of claim 12, wherein the second rod is elastically installed in the second actuator.

17. The unmanned aerial vehicle of claim 16, further comprising a second coil spring connected to the second rod in the second actuator and configured to generate an elastic force on the second rod.

18. The unmanned aerial vehicle of claim 16, wherein a direction of the elastic force acting on the second rod is opposite to a direction of an elastic force acting on the first rod.

19. The unmanned aerial vehicle of claim 12, further comprising:
a trigger controller configured to control the trigger actuator; and
a thrust-generator configured to move the fuselage.

20. The unmanned aerial vehicle of claim 19, wherein the trigger controller is further configured to operate the trigger actuator to retract the main wings.

21. The unmanned aerial vehicle of claim 12, wherein, in a first state:
the main wings are overlapped with the fuselage by an external force,
the first rod is elastically compressed in the first actuator, and
the second rod is restricted by the trigger actuator,
wherein the control assembly is further configured to change from the first state to a second state based on a release of the external force, and
wherein, in the second state:
the main wings are fixed at a first sweep angle with respect to the fuselage,
the first rod is restricted by the first elastic lock, and
the second rod is restricted by the trigger actuator.

22. The unmanned aerial vehicle of claim 21, wherein the control assembly is further configured to change from the second state to a third state based on an operation of the trigger actuator, and
wherein, in the third state:
the main wings are fixed at a second sweep angle that is greater than the first sweep angle,
the first rod is restricted by the first elastic lock, and
the second rod is restricted by the second elastic lock.

23. A system for controlling a wing sweep angle, the system comprising:
main wings rotatably connected to a fuselage; and
a control assembly configured to deploy or retract the main wings, and fix the main wings at two or more sweep angles,
wherein the control assembly comprises:
a link assembly connected to the main wings;
a first actuator comprising:
a first rod connected to the link assembly,
a first coil spring connected to the first rod and configured to generate an elastic force on the first rod, and
a first elastic lock configured to restrict a movement of the first rod; and
a second actuator fixed to the fuselage and comprising:
a second rod connected to the first actuator and configured to move with the first actuator,
a second elastic lock configured to restrict a movement of the second rod, and
a trigger actuator comprising a trigger configured to release a restriction of the second rod.
